(19) United States
(12) Patent Application Publication
(10) Pub. No.: US 2022/0374894 A1
(43) Pub. Date: Nov. 24, 2022

(54) INTEGRATED PAYMENT TRAVEL MANAGEMENT SYSTEM

(71) Applicant: AMADEUS S.A.S., Biot (FR)

(72) Inventors: Mathieu Le Marier, Geneva (CH); Rohan Jain, London (GB); Antonin Guéroult, Biot (FR); Sandy Martin, Antibes (FR); Sabrine Taissi, Antibes (FR); Yizhen Zhang, Valbonne (FR)

(21) Appl. No.: 17/326,745

(22) Filed: May 21, 2021

(51) Int. Cl. G06Q 20/40; G06Q 10/02

(52) U.S. Cl. CPC G06Q 20/4014; G06Q 20/4015; G06Q 20/4016; G06Q 10/02

(57) ABSTRACT

Methods, systems, and computer program products for implementing a payment integration process for travel management systems. A payment integration request associated with a payment identification from a travel provider system is received. Payment transaction data associated with the payment identification from a payment gateway using the payment identification is obtained. Travel records data associated with the payment identification from a reservation system is obtained. Payment integration data associated with the payment identification is determined by performing a sanity check of the payment transaction data and the travel record data, validating the payment transaction data and the travel record data, and generating the payment integration data based on the sanity check and the validation of the payment transaction data and the travel record data. Payment integration data to be integrated into the travel record is provided.

### TECHNICAL FIELD

The present invention generally relates to computers and computer software, and more specifically, to methods, systems, and computer program products for implementing a payment integration process.

### BACKGROUND

In order for a travel provider to be able to handle moving towards a more standard retail industry approach for payment transactions (e.g., modern touchpoints, frictionless flows, removing intermediaries, and the like), a travel provider needs to ensure that the payment data will be consistent for their respective back-office processing. The modern touchpoints are also introducing ad hoc multi-step payment experience.

In some conventional reservation systems, payment information is provided in a manner such that the payment information cannot be authenticated. For example, a travel customer may communicate with a travel agent using telephone communication, and the travel customer may provide the travel agent payment information verbally. In this example, the travel agent enters the payment information at a reservation device, such as a computer, and the payment information is not verified/authenticated. As another example, if a travel customer books travel with a travel agent in person, unless the travel agency is equipped with electronic payment capture devices (i.e., credit card readers, etc.), the payment information (e.g., a credit card number) may still be fraudulent. As such, for these conventional payment channels for travel reservations, the payments submitted through such channels may be considered unsecure.

In general, unsecured payments increase costs for travel merchants (e.g., airlines, rail travel providers, hotels, etc.), travel booking systems (e.g., global distribution systems), and/or third party reservation services (e.g., travel agencies), as liability for fraudulent payments through unsecured payment channels typically remains with the travel merchant, travel booking system, and/or third party reservation service. In addition, because the travel merchant, booking system, and/or third-party reservation service handle the payment information for such unsecured payment channels, the travel merchant, booking system, and/or third-party reservation service may be required to comply with various security standards for sensitive payment information. For example, the travel merchant, booking system, and/or third-party reservation service may be required to comply with the Payment Card Industry Data Security Standard (PCI DSS), which is an information security standard for organizations that handle cardholder information for many debit, credit, prepaid, e-purse, ATM, and point of sale (POS) payment cards. Complying with such standards typically increases costs associated with processing payments for travel reservations.

Moreover, many travel merchants and reservation systems utilize a travel agency selling model, i.e., travel agencies distribute a travel merchant's products on behalf of the travel merchant. However, the travel merchant generally is liable for the payment, even in the case of fraudulent payments. Therefore, in conventional systems utilizing the travel agency selling model, travel merchants are generally dependent on travel agency procedures to secure payments.

Whenever travel merchants and reservation systems accept payment, they need to be sure that the data is consistent and that they are able to provide all necessary information (e.g., the code, etc.) that they might require for the eventual accounting reconciliation purpose. For example, the travel merchants need to ensure that data is available for their back office and have the capability to maintain an integration of payment data inside their booking system. Thus, improved methods, systems, and computer program products for providing improved payment integration systems for travel bookings are needed.

### SUMMARY

In embodiments of the invention, a method for implementing a payment integration process. The method includes receiving, at a payment integration server, a payment integration request associated with a travel record identification from a travel provider system, wherein the payment integration request includes a payment identification associated with the travel record identification. The method further includes obtaining, at the payment integration server, payment transaction data associated with the travel record identification from a payment gateway using the payment identification. The method further includes obtaining, at the payment integration server, travel records data associated with the travel record identification from a reservation system, wherein the reservation system processed the travel record identification. The method further includes determining payment integration data associated with the payment identification by performing a validity check of the travel record identification and the payment identification, performing a sanity check of the payment transaction data and the travel record data, and generating the payment integration data based on the validity check of the travel record identification and the payment identification and the sanity check of the payment transaction data and the travel record data. The method further includes providing, by the payment integration server to the travel provider system, the payment integration data to be integrated into the travel record.

These and other embodiments can each optionally include one or more of the following features.

In some embodiments of the invention, performing the sanity check of the payment transaction data and the travel record data includes determining that the travel provider system has access to a particular set of data of the payment transaction data and the travel record data.

In some embodiments of the invention, the method further includes determining configuration data according to the travel provider system having access to the particular set of data of the payment transaction data and the travel record data.

In some embodiments of the invention, generating the payment integration data based on the validity check of the travel record identification and the payment identification and the sanity check of the payment transaction data and the travel record data is customizable based on the configuration data.

In some embodiments of the invention, the method further includes updating an activation map based on the configuration data, wherein the activation map includes associations between a plurality of travel provider systems and a respective access level for each of the travel provider systems.

In some embodiments of the invention, performing the sanity check of the payment transaction data and the travel record data includes a record locator consistency check that includes an identification check between the payment identification and the travel record identification.

In some embodiments of the invention, the method further includes storing the travel record associated with the payment integration data in a payment integration database in accordance with generating the payment integration data.

In some embodiments of the invention, the payment integration data includes at least one of data validity results, transactional data associated with the payment identification, a payment instrument, authorization information, authentication information, and risk assessment information.

In some embodiments of the invention, performing the validity check of the travel record identification and the payment identification includes determining that the payment identification has not been already received by comparing the payment identification to other received payment identifications.

In some embodiments of the invention, performing the sanity check of the payment transaction data and the travel record data includes determining that a merchant associated with the payment transaction data matches a merchant associated with the travel record data, determining that authorization of payment associated with the payment transaction data was successful, determining that an authorization associated with the payment transaction data is valid based on an authorization time stamp, determining that there is not an attempted follow-up operation or a pending follow-up operation associated with the payment transaction data, determining that an amount and currency of payment associated with the payment transaction data is available, and/or determining that a payment instrument associated with the payment.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 illustrates a distributed database environment for implementing a payment integration process, according to embodiments of the invention.

FIG. 2 illustrates an example routine in the form of a sequence diagram that may be performed by the distributed database environment shown in FIG. 1 as a procedure to facilitate a payment integration process for a travel booking, according to embodiments of the invention.

FIG. 3 illustrates example payment integration processes based on a payment integration request, according to embodiments of the invention.

FIG. 4 is a flowchart of an example process for providing payment integration data based on a payment integration request, according to embodiments of the invention.

FIG. 5 is a block diagram showing an example computer architecture for a computer capable of executing the software components described herein, according to embodiments described herein.

### DETAILED DESCRIPTION

In order for a travel provider to be able to handle moving towards a more standard retail industry approach for payment transactions (e.g., modern touchpoints, frictionless flows, removing intermediaries, and the like), a travel provider needs to ensure that the payment data will be consistent for their respective back-office processing. Embodiments of this invention provide different capabilities to maintain the payment result via a payment integration process for a travel provider system, as it is a key value for International Air Transport Association (IATA) customers. For example, the airline industry is moving via changes on their respective application programming interfaces (API's) to offer richer content and customize a traveler's experience. Additionally, the airline retailing journey is moving via changes on the passenger service system (PSS) system to remove legacy ticket and passenger name record (PNR) systems. For example, embodiments of this invention further cover the payment integration with travel providers using the IATA One Order system (e.g., One Order is a single customer order record, holding all data elements obtained and required for order fulfilment across the air travel cycle, i.e., customer data, order items, payment and billing information, fulfilment data and status).

Embodiments of the invention are related to systems and methods for implementing a payment integration process that decorrelates the payment and the issuance using a database associating payment record identification (PRID) and the form of payment (FOP). Decorrelation refers to a process that is used to reduce autocorrelation within a signal, or cross-correlation within a set of signals, while preserving other aspects of the signal. Embodiment of the invention reduces autocorrelation within cross-correlation of a set of signals (e.g., PRID and FOP), based on a validity check of the travel merchant ID and the PRID (e.g., forming one pair of data) on one side, and an activation map and a sanity check on the other side, in order to securely control the access to the FOP (e.g., secure payment processing). The payment integration process utilizes one or more payment integration servers that are in communication with travel providers, reservation systems, and payment processors via a payment platform gateway. The payment integration process utilizes a validation module for validity checks, a data mapping module for managing a payment record database, and a configuration module for tracking, via an activation map, associated access levels for each travel provider system based on a certain set of data from the payment transaction data.

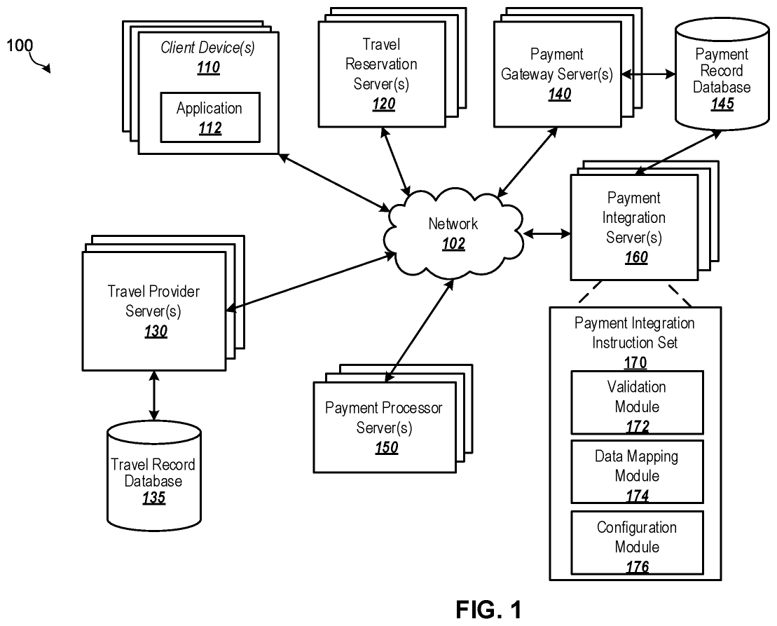

FIG. 1 is an example environment 100 of a distributed database environment for implementing a payment integration process, according to embodiments of the invention. The example environment 100 includes one or more client device(s) 110, one or more travel reservation server(s) 120, one or more travel provider server(s) 130, one or more payment gateway server(s) 140, one or more payment processor server(s) 150, and one or more payment integration server(s) 160, that communicate over a data communication network 102, e.g., a local area network (LAN), a wide area network (WAN), the Internet, a mobile network, or a combination thereof.

The one or more client device(s) 110 (e.g., a device used by a requestor) can include a desktop, a laptop, a server, or a mobile device, such as a smartphone, tablet computer, wearable device (e.g., smartwatch), in-car computing device, and/or other types of mobile devices. The one or more client device(s) 110 includes applications, such as the application 112, for managing a travel booking request to/from the one or more travel reservation server(s) 120. The one or more client device(s) 110 can include other applications. The one or more client device(s) 110 initiates a travel booking request by a requestor via application 112. The travel booking request may include availability search queries by requesting entities (such as clients, applications, browsers installed on user terminals, etc.) in the course of a search (e.g., airline booking search). The one or more client device(s) 110 may be utilized by a customer to review a reserved travel booking and provide and authenticate payment information for the reserved travel booking. Additionally, a requestor of a travel booking using the one or more client device(s) 110 may include an airline agency, travel agency, other dedicated global distribution systems (GDS), as for example airlines reservation systems which provide flight search applications for shopping business like flight booking, and the like.

The one or more travel reservation server(s) 120 manages travel booking requests received from application 112 from the one or more client devices 110. The one or more travel reservation server(s) 120 may be a personal computing device, tablet computer, thin client terminal, smart phone and/or other such computing device. The one or more travel reservation server(s) 120 receive booking data from a client device to reserve a travel reservation and generate a PNR for that particular travel product(s) associated with the booking data. As such, in general, a reservation application executes on a reservation device (e.g., application 112 on client device 110) to generate a front end through which a travel agent may interface with the reservation server 120 to reserve a travel booking for a travel customer. For example, a reservation device executing a reservation application may operate as a remote terminal connected to reservation server 120, and a travel agent may reserve a travel booking for a travel customer by interfacing with the reservation server 120 using the client device 110. For example, the client device 110 executing the reservation application may provide a command-line interface to a GDS embodied by the reservation server 120. In this example, the booking data communicated by the client device 110 may be in a travel agency format, such as command-line. Additionally, after a consumer on a client device 110 confirms an issuance for the particular travel product(s) associated with the booking data, a travel reservation server 120 initiates a payment process by sending an order request to the one or more travel provider server(s) 130 associated with the requested travel product(s) from the consumer.

The one or more travel provider server(s) 130 (e.g., travel merchants) generally include airlines, rail travel providers, hotels, and/or other such merchants that offer travel or travel-related services to customers using client devices 110. The one or more travel provider server(s) 130 generally facilitate remote communication therewith to reserve travel or travel-related service from a particular travel merchant. After a consumer on a client device 110 confirms an issuance for the particular travel product(s) associated with the booking data, a travel provider server 130 receives an order request from a travel reservation server 120 and initiates a payment process by requesting payment from the client device 110. After receiving a payment confirmation for a particular travel booking, a travel provider server 130 may request and receive a travel record ID from the reservation server 120 and send booking confirmation to the client device 110 via the reservation server 120. Additionally, the one or more travel provider server(s) 130 are configured to initiate a payment integration process after receiving a payment confirmation from the one or more payment processor server(s) 150 via the one or more payment gateway server(s) 140 and sending booking confirmation data by sending a payment integration request to the one or more payment integration server(s) 160.

The one or more travel provider server(s) 130 may be front end server(s) for managing, collecting, processing, and communicating travel records (e.g., travel booking requests, resource information, revenues management data, bookings data, airlines/system configurations data, etc.), that is stored in the travel record database 135. Further, the one or more travel provider server(s) 130 may be front end server(s) for managing, collecting, processing, and communicating payment integration requests and payment integration data from one or more payment integration server(s) 160 to the one or more reservation server(s) 120.

The one or more payment gateway server(s) 140 manages the payment transactions of travel booking requests received from application 112 between the one or more client devices 110 and the payment processor server(s) 150. The management protocols of the one or more payment gateway server(s) 140 may be based on a redundant load-balancing system by managing multiple clients (e.g., client device(s) 110) so that a payment associated with a travel booking request is handled by one of the one or more payment processor server(s) 150. For example, there may be multiple payment processor server(s) 150 that are able to service the travel booking payment, and the redundant load-balancing system of the payment gateway server(s) 140 is responsible for ensuring that the travel booking request is performed by one of the capable payment processor server(s) 150. Payment processors include for example, a credit/debit card issuer, a bank, digital payment service, etc., and the one or more servers for each payment processor generally facilitate remote communication therewith to authenticate and/or authorize a payment via a payment gateway server 140.

The one or more payment integration server(s) 160 receives and processes the payment integration request(s) from a travel provider server 120. The one or more payment integration server(s) 160 includes a payment integration instruction set 170 that perform a payment integration protocol according to processes described herein. The payment integration instruction set 170 includes a validation module 172 for performing validity checks of travel record identifications and payment identifications. The validity check of the travel record identification and the payment identification may include determining that the payment identification has not been already received by comparing the payment identification to other received payment identifications (e.g., data mapping processing—it helps to determines whether business reconciliation process has already been performed). Additionally, the validation module 172 performs sanity checks of the payment transaction data and the travel record data. The sanity check of the payment transaction data and the travel record data may include a record locator consistency check that includes an identification check between the payment identification and the travel record identification (e.g., a record locator (RLOC) consistency check). Additional sanity checks may include merchant matching, authorization approval and whether it was recent based on a time stamp, checking for follow-up or pending operations, confirming amount and currency of payment, and payment instrument matching.

In some implementations of the invention, the payment integration instruction set 170 further includes a data mapping module 174 for managing a payment record database 165. In an exemplary embodiment of the invention, the payment record database 165 can be accessed by the payment integration server(s) 160 via the data mapping module 174 of the payment integration instruction set 170. The payment integration instruction set 170 further includes a configuration module 176 for tracking, via an activation map, associated access levels for each travel provider based on a certain set of data from the payment transaction data. In some implementations of the invention, the activation map includes associations between a plurality of travel provider systems and a respective access level for each of the travel provider systems (e.g., an activation map shows which customers are activated for which level of features).

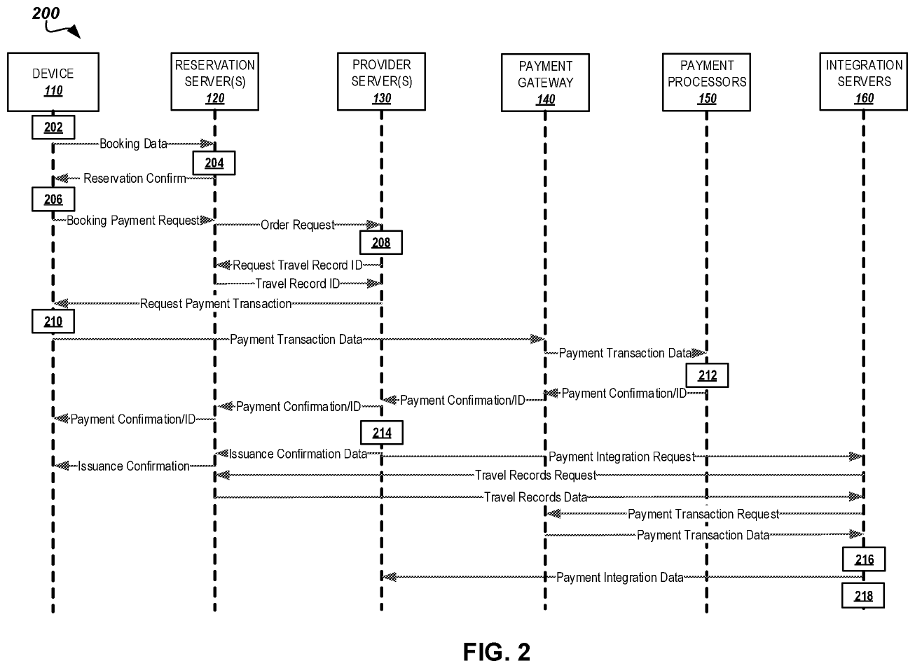

An example routine of implementing a payment integration protocol as illustrated in the environment of FIG. 1 is further discussed herein with reference to sequence diagram 200 of FIG. 2.

FIG. 2 illustrates an example routine in the form of a sequence diagram 200 that may be performed by the distributed database environment shown in FIG. 1 as a procedure to facilitate a payment integration process for a travel booking, according to embodiments of the invention. FIG. 2 provides an exemplary routine that may be performed by the client device 110, the reservation server(s) 120, the travel provider server(s) 130, the payment gateway server(s) 140, the payment processor server(s) 150, and/or the payment integration server(s) 160 consistent with some embodiments of the invention to process a secure payment for a reserved travel booking via a payment integration protocol. The sequence diagram 200 is initiated at block 202 at a client device 110 via application 112 (e.g., a travel request is entered at a consumer device). The travel booking request is received by a reservation server 120. In response, at block 204, the reservation server 120 reserves a travel booking associated with the booking request and generates an associated PNR. A reservation confirmation is communicated from the reservation server 120 to the client device 110 (e.g., a temporary travel reservation is made, pending consumer confirmation and payment).

At block 206, consumer confirmation for the reservation is entered at the client device 110 (e.g., the traveler wants to proceed to pay for the ticket), and a booking payment request is communicated to the reservation servers 120. The reservation servers 120 then communicate an order request to the travel provider server 130. At block 208, the travel provider server 130, in response to the order request, stores the associated PNR for the travel reservation in the travel record database 135. According to some implementations of the invention, after receiving the order request, the travel provider server 130 requests and receives the travel record ID from the travel reservation server 120. The travel provider server 130 then sends a request for a payment transaction (e.g., FOP and payment data) to the client device 110. The travel provider server 130 can request the payment transaction via the reservation server 120, or directly communicate the request to the client device 110 (e.g., a payment portal window/application). At block 210, the payment transaction data (e.g., FOP and payment information) is entered at the client device 110, and the payment transaction data is communicated to one of the payment processor servers 150 via the one or more payment gateway server(s) 140.

At block 212, the payment processor server 150 (e.g., the processor selected by the gateway servers 140) conducts the payment transaction with a processor (e.g., a bank, a credit/debit card issuer, a digital payment service, etc.). The payment processor server 150 communicates a payment confirmation message (e.g., a payment confirmation ID) to the client device 110, the reservation servers 120, and/or the travel provider servers 130, via the payment gateway servers 140. As illustrated, the payment confirmation message may be trickled down to the client device 110 (e.g., from the payment processor to the payment gateway to the travel provider to the travel reservation server, and then to the client device 110). Alternatively, the payment processor server 150 may directly send the payment confirmation message to the client device 110, and the payment gateway server 150 may communication the payment confirmation ID to the travel provider server 130. According to some implementations of the invention, after receiving the payment confirmation message and/or payment confirmation ID, the travel provider server 130 requests and receives the travel record ID from the travel reservation server 120. In addition, the travel provider server 130 may send booking confirmation data to the travel reservation server 120, and in response, the travel reservation server 120 can communicate an issuance confirmation message to the client device. The issuance confirmation may be generated before, during (e.g., at the same time, initiated at block 214), or right after the payment integration protocol initiates at block 214, as further described herein.

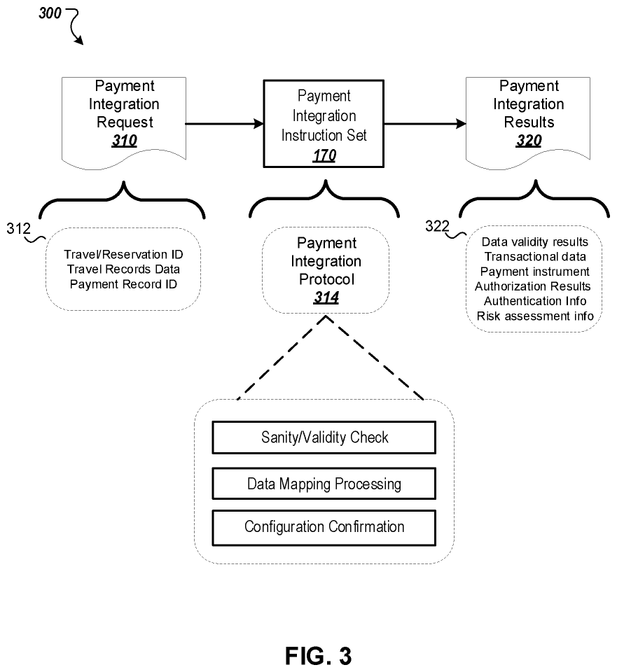

According to an exemplary implementation of the invention, after receiving the payment confirmation message and/or the payment confirmation ID, the travel provider server 130, at block 214, initiates a payment integration protocol by communicating a payment integration request to one of the payment integration servers 160. The payment integration server 160 requests and receives travel records data from the travel reservation server 120 associated with the travel booking. The payment integration server 160 then requests and receives payment transaction information associated with the travel booking from one of the payment gateway servers 140. At block 216, the payment integration server 160 processes payment integration by decorrelating the payment data and the travel records data by associating PRID and the FOP associated with the travel booking and generates payment integration data associated with the travel booking. The payment integration server 160 communicates the payment integration data with the travel provider server 130 associated with the travel booking. At block 218, the payment integration server 160 then updates the payment record database 165 with the payment integration data associated with the travel booking (e.g., associated with the PRID, the FOP, and the PNR for the particular travel request). The actions of the payment integration server(s) 160 utilizing the payment integration instruction set 170 to process a payment integration protocol are further described herein with reference to the illustration in FIG. 3.

FIG. 3 illustrates an example payment integration processes based on a payment integration request, according to embodiments of the invention. In particular, FIG. 3 illustrates an example environment 300 for a payment integration implementation for determining payment integration of a payment integration request. The objective for the payment integration instruction set 170 is that the payment data which is retrieved from the payment providers, travel providers, etc., through a payment gateway (e.g., payment gateway servers 140, is properly mapped and can be reused without any gap from an travel provider perspective inside their revenue account system, even if the payment is standalone. For example, the payment integration instruction set 170, stored on one or more payment integration server(s) 160, receives a payment integration request 310 (e.g., from a travel provider server 130). The payment integration request 310 includes payment integration request information 312 (e.g., travel/reservation ID, travel records data, payment record ID, etc.) that is associated with a travel reservation. In some implementations, the complete set of payment data is not in the request query (e.g., payment integration request information 312), however, the payment record ID allows the payment integration instruction set 170 to identify the payment transaction in the database to retrieve all the related payment data.

The payment integration instruction set 170 initiates a payment integration protocol 314 (e.g., block 214 of FIG. 2) to generate payment integration data 320. The payment integration protocol 314 includes a sanity check and a validity check, data mapping processing, and configuration confirmation. For example, the validation module 172 performs a validity check of the payment integration request information 312 (e.g., the travel record data) by determining that a payment identification of the payment transaction data has not been already received by comparing the payment identification to other received payment identifications. Additionally, the validation module 172 performs a sanity check of the payment integration request information 312 (e.g., the payment transaction data and the travel record data) by performing a record locator consistency check that includes an identification check between the payment identification and the travel record identification (e.g., a record locator (RLOC) consistency check). Performing the sanity check of the payment transaction data and the travel record data may include determining that the travel provider system has access to a particular set of data of the payment transaction data and the travel record data. Additional sanity checks may include merchant matching, authorization approval and whether it was recent based on a time stamp, checking for follow-up or pending operations, confirming amount and currency of payment, and payment instrument matching.

In some implementations of the invention, the data mapping processing via the data mapping module 174 and the payment record database 165 includes a data mapping scheme (e.g., mapping information between a payment platform and storing the mapped payment data the payment record database 165). In some implementations of the invention, the configuration module 176 performs configuration confirmation for tracking, via an activation map, associated access levels for each travel provider based on a certain set of data from the payment transaction data. In some implementations of the invention, the activation map includes associations between a plurality of travel provider systems and a respective access level for each of the travel provider systems (e.g., an activation map shows which customers are activated for which level of features).

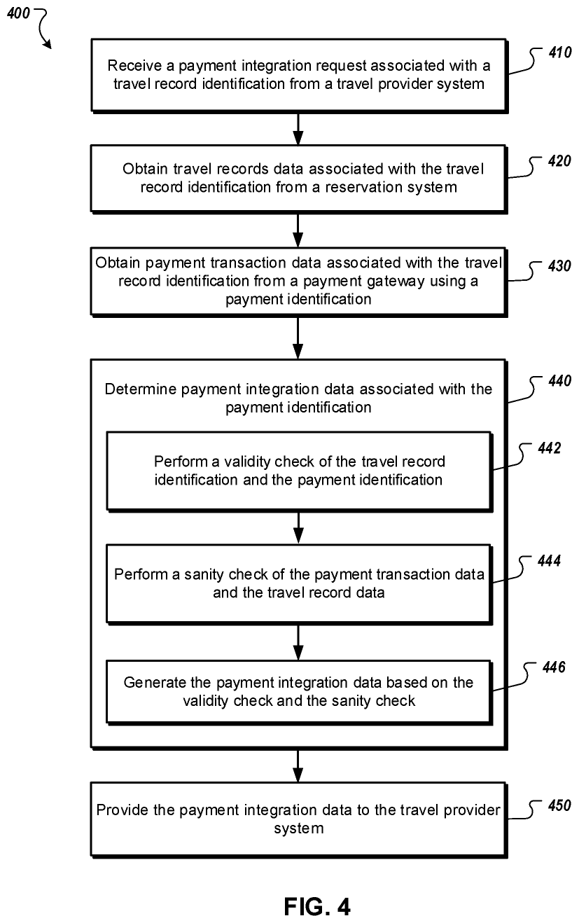

The payment integration data 320 may include payment integration results data 322 such as data validity results, transactional data associated with the payment transaction, the payment instrument, authorization results, authentication information, and risk assessment information. An example process of implementing a payment integration protocol as illustrated in FIG. 3 is further discussed herein with reference to process 400 of FIG. 4.

FIG. 4 illustrates a flowchart of an example process 400 for providing payment integration data based on a payment integration request, according to embodiments of the invention. Operations of the process 400 can be implemented, for example, by a system that includes one or more data processing apparatus, such as one or more payment integration server(s) 160 of FIG. 1. The process 400 can also be implemented by instructions stored on computer storage medium, where execution of the instructions by a system that includes a data processing apparatus cause the data processing apparatus to perform the operations of the process 400.

The system receives a payment integration request associated with a travel record identification from a travel provider system (410). For example, as illustrated in the sequence diagram 200 of FIG. 2, at block 214, the travel provider server 130, initiates a payment integration protocol by communicating a payment integration request to one of the payment integration servers 160.

The system obtains travel records data associated with the travel record identification from a reservation system (420). For example, as illustrated in the sequence diagram 200 of FIG. 2, after the payment integration server 160 receives payment transaction information associated with the travel booking from one of the payment gateway servers 140, the payment integration server 160 requests and receives travel records data from the travel reservation server 120 associated with the travel booking.

The system obtains payment transaction data associated with the travel record identification from a payment gateway using a payment identification (430). For example, as illustrated in the sequence diagram 200 of FIG. 2, at block 210, the payment transaction data (e.g., FOP and payment information) is entered at the client device 110, and the payment transaction data is communicated to one of the payment processor servers 150 via the one or more payment gateway server(s) 140.

The system determines payment integration data associated with the payment identification (440). In particular, to determine the payment integration data, the system performs a validity check of the travel record identification and the payment identification (442), performs a sanity check of the payment transaction data and the travel record data (444), and generates the payment integration data based on the validity check and the sanity check (446). For example, as illustrated in FIG. 3, the payment integration instruction set 170 initiates a payment integration protocol 314 (e.g., block 214 of FIG. 2) to generate payment integration data 320, where the payment integration protocol 314 includes a sanity check and a validity check, data mapping processing, and configuration confirmation.

In some implementations of the invention, performing the validity check of the travel record identification and the payment identification includes determining that the payment identification has not been already received by comparing the payment identification to other received payment identifications. For example, for data mapping processing, the validity check aids in determining whether a business reconciliation process has already been performed.

In some implementations of the invention, performing the sanity check of the payment transaction data and the travel record data may include determining that the travel provider system has access to a particular set of data of the payment transaction data and the travel record data. In some implementations of the invention, process 400 further includes determining configuration data according to the travel provider system having access to the particular set of data of the payment transaction data and the travel record data. In some implementations of the invention, generating the payment integration data based on the validity check of the travel record identification and the payment identification and the sanity check of the payment transaction data and the travel record data is customizable based on the configuration data. In some implementations of the invention, process 400 further includes updating an activation map based on the configuration data, wherein the activation map includes associations between a plurality of travel provider systems and a respective access level for each of the travel provider systems. For example, an activation map shows which customers are activated for which level of features.

In some implementations of the invention, performing a sanity check includes a record locator consistency check that includes an identification check between the payment identification and the travel record identification (e.g., a record locator (RLOC) consistency check). Additional sanity checks may include merchant matching, authorization approval and whether it was recent based on a time stamp, checking for follow-up or pending operations, confirming amount and currency of payment, and payment instrument matching. For example, in some implementations of the invention, performing the sanity check of the payment transaction data and the travel record data includes determining that a merchant associated with the payment transaction data matches a merchant associated with the travel record data (e.g., merchant matching). Additionally, or alternatively, performing the sanity check of the payment transaction data and the travel record data includes determining that authorization of payment associated with the payment transaction data was successful (e.g., authorization approval confirmation). Additionally, or alternatively, performing the sanity check of the payment transaction data and the travel record data includes determining that an authorization associated with the payment transaction data is valid based on an authorization time stamp (e.g., recent authorization verification, i.e., 14 days old max by default). Additionally, or alternatively, performing the sanity check of the payment transaction data and the travel record data includes determining that there is not an attempted follow-up operation or a pending follow-up operation associated with the payment transaction data (e.g., verification of follow-up or pending actions). Additionally, or alternatively, performing the sanity check of the payment transaction data and the travel record data includes determining that an amount and currency of payment associated with the payment transaction data is available (e.g., currency verification). Additionally, or alternatively, performing the sanity check of the payment transaction data and the travel record data includes determining that a payment instrument associated with the payment transaction data matches a payment instrument associated with the travel record data (e.g., payment instrument matching).

In some implementations of the invention, based on generating the payment integration data, the process 400 further includes storing the travel record associated with the payment integration data in a payment integration database (e.g., payment record database 165). For example, a data mapping process may include storing the updated payment record, which adds of payment data in the travel database.

The system provides the payment integration data to the travel provider system (450). For example, as illustrated in FIG. 2, after the payment integration server 160 processes payment integration by decorrelating the payment data and the travel records data by associating PRID and the FOP associated with the travel booking and generates payment integration data associated with the travel booking at block 216, the payment integration server 160 communicates the payment integration data with the travel provider server 130 associated with the travel booking.

In some implementations of the invention, the payment integration data includes at least one of data validity results, transactional data associated with the payment identification, a payment instrument, authorization information, authentication information, and risk assessment information.

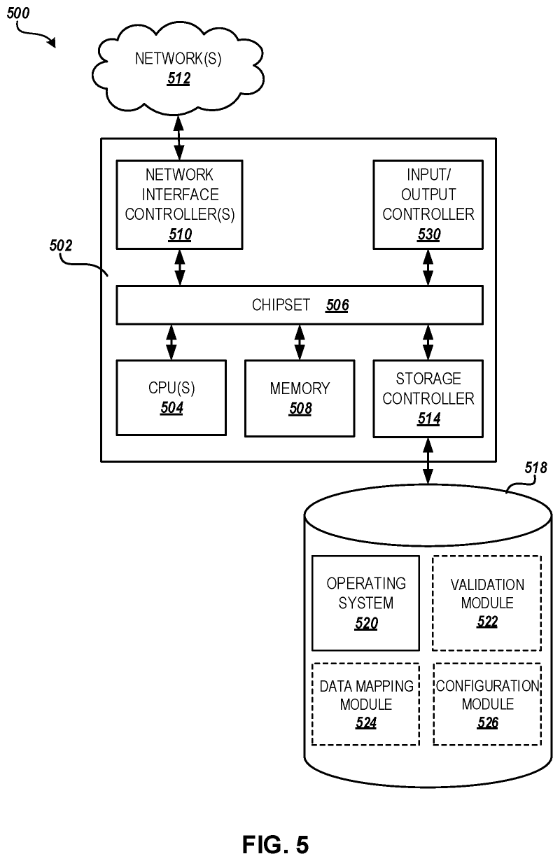

FIG. 5 illustrates an example computer architecture 500 for a computer 502 capable of executing the software components described herein for the sending/receiving and processing of tasks. The computer architecture 500 (also referred to herein as a “server”) shown in FIG. 5 illustrates a server computer, workstation, desktop computer, laptop, a server operating in a cloud environment, or other computing device, and may be utilized to execute any aspects of the software components presented herein described as executing on a host server, or other computing platform. The computer 502 preferably includes a baseboard, or “motherboard,” which is a printed circuit board to which a multitude of components or devices may be connected by way of a system bus or other electrical communication paths. In one illustrative embodiment, one or more central processing units (CPUs) 504 operate in conjunction with a chipset 506. The CPUs 504 can be programmable processors that perform arithmetic and logical operations necessary for the operation of the computer 502.

The CPUs 504 preferably perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, or the like.

The chipset 506 provides an interface between the CPUs 504 and the remainder of the components and devices on the baseboard. The chipset 506 may provide an interface to a memory 508. The memory 508 may include a random access memory (RAM) used as the main memory in the computer 502. The memory 508 may further include a computer-readable storage medium such as a read-only memory (ROM) or non-volatile RAM (NVRAM) for storing basic routines that that help to startup the computer 502 and to transfer information between the various components and devices. The ROM or NVRAM may also store other software components necessary for the operation of the computer 502 in accordance with the embodiments described herein.

According to various embodiments, the computer 502 may operate in a networked environment using logical connections to remote computing devices through one or more networks 512, a local-area network (LAN), a wide-area network (WAN), the Internet, or any other networking topology known in the art that connects the computer 502 to the devices and other remote computers. The chipset 506 includes functionality for providing network connectivity through one or more network interface controllers (NICs) 510, such as a gigabit Ethernet adapter. For example, the NIC 510 may be capable of connecting the computer 502 to other computer devices in the utility provider's systems. It should be appreciated that any number of NICs 510 may be present in the computer 502, connecting the computer to other types of networks and remote computer systems beyond those described herein.

The computer 502 may be connected to at least one mass storage device 518 that provides non-volatile storage for the computer 502. The mass storage device 518 may store system programs, application programs, other program modules, and data, which are described in greater detail herein. The mass storage device 518 may be connected to the computer 502 through a storage controller 514 connected to the chipset 506. The mass storage device 518 may consist of one or more physical storage units. The storage controller 514 may interface with the physical storage units through a serial attached SCSI (SAS) interface, a serial advanced technology attachment (SATA) interface, a fiber channel (FC) interface, or other standard interface for physically connecting and transferring data between computers and physical storage devices.

The computer 502 may store data on the mass storage device 518 by transforming the physical state of the physical storage units to reflect the information being stored. The specific transformation of physical state may depend on various factors, in different embodiments of the invention of this description. Examples of such factors may include, but are not limited to, the technology used to implement the physical storage units, whether the mass storage device 518 is characterized as primary or secondary storage, or the like. For example, the computer 502 may store information to the mass storage device 518 by issuing instructions through the storage controller 514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 502 may further read information from the mass storage device 518 by detecting the physical states or characteristics of one or more particular locations within the physical storage units.

The mass storage device 518 may store an operating system 520 utilized to control the operation of the computer 502. According to some embodiments, the operating system includes the LINUX operating system. According to another embodiment, the operating system includes the WINDOWS® SERVER operating system from MICROSOFT Corporation of Redmond, Wash. According to further embodiments, the operating system may include the UNIX or SOLARIS operating systems. It should be appreciated that other operating systems may also be utilized. The mass storage device 518 may store other system or application programs and data utilized by the computer 502, such as validation module 522 to perform the validity and sanity checks for a payment integration process, a data mapping module 524 for managing a payment record database for a payment integration process, and a configuration module 526 for tracking, via an activation map, associated access levels for a payment integration process, according to embodiments described herein.

In some embodiments, the mass storage device 518 may be encoded with computer-executable instructions that, when loaded into the computer 502, transforms the computer 502 from being a general-purpose computing system into a special-purpose computer capable of implementing the embodiments described herein. These computer-executable instructions transform the computer 502 by specifying how the CPUs 504 transition between states, as described above. According to some embodiments, from the payment integration server(s) 160 perspective, the mass storage device 518 stores computer-executable instructions that, when executed by the computer 502, perform portions of the process 400, for implementing a payment integration system, as described herein. In further embodiments, the computer 502 may have access to other computer-readable storage medium in addition to or as an alternative to the mass storage device 518.

The computer 502 may also include an input/output controller 530 for receiving and processing input from a number of input devices, such as a keyboard, a mouse, a touchpad, a touch screen, an electronic stylus, or other type of input device. Similarly, the input/output controller 530 may provide output to a display device, such as a computer monitor, a flat-panel display, a digital projector, a printer, a plotter, or other type of output device. It will be appreciated that the computer 502 may not include all of the components shown in FIG. 5, may include other components that are not explicitly shown in FIG. 5, or may utilize an architecture completely different than that shown in FIG. 5.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically includes computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

1. A computing apparatus comprising:
one or more processors;
at least one memory device coupled with the one or more processors; and
a data communications interface operably associated with the one or more processors,
wherein the at least one memory device contains a plurality of program instructions that, when executed by the one or more processors, cause the one or more processors to perform the steps of:
receiving a payment integration request associated with a travel record identification from a travel provider system, wherein the payment integration request includes a payment identification associated with a travel record identification;
obtaining payment transaction data associated with the travel record identification from a payment gateway utilizing the payment identification;
obtaining travel records data associated with the travel record identification from a reservation system, wherein the reservation system processed the travel record identification;
performing a validity check of the travel record identification and the payment identification by determining that an authorization associated with the payment transaction data is valid based on an authorization time stamp associated with the travel record identification;
performing a sanity check of the payment transaction data and the travel record data by comparing the payment identification and the travel record identification for a match;
generating payment integration data based on integrating the results of the validity check of the travel record identification and the payment identification and the results of the sanity check of the payment transaction data and the travel record data; and
providing, to the travel provider system, the payment integration data and payment integration instructions, wherein the travel provider system to integrates the payment integration data into the travel record based on the payment integration instructions.

2. The computing apparatus of claim 1, wherein performing the sanity check of the payment transaction data and the travel record data comprises determining that the travel provider system has access to a particular set of data of the payment transaction data and the travel record data.

3. The computing apparatus of claim 2, wherein the plurality of program instructions, when executed by the one or more processors, further cause the one or more processors to perform the steps of:
determining configuration data according to the travel provider system having access to the particular set of data of the payment transaction data and the travel record data.

4. The computing apparatus of claim 3, wherein generating the payment integration data based on the validity check of the travel record identification and the payment identification and the sanity check of the payment transaction data and the travel record data is customizable based on the configuration data.

5. The computing apparatus of claim 3, wherein the plurality of program instructions, when executed by the one or more processors, further cause the one or more processors to perform the steps of:
updating an activation map based on the configuration data, wherein the activation map includes associations between a plurality of travel provider systems and a respective access level for each of the travel provider systems.

6. The computing apparatus of claim 1, wherein performing the sanity check of the payment transaction data and the travel record data comprises a record locator consistency check that includes an identification check between the payment identification and the travel record identification.

7. The computing apparatus of claim 1, wherein, in accordance with generating the payment integration data, the plurality of program instructions, when executed by the one or more processors, further cause the one or more processors to perform the steps of:
storing the travel record associated with the payment integration data in a payment integration database.

8. The computing apparatus of claim 1, wherein the payment integration data includes at least one of data validity results, transactional data associated with the payment identification, a payment instrument, authorization information, authentication information, and risk assessment information.

9. The computing apparatus of claim 1, wherein performing the validity check of the travel record identification and the payment identification comprises comparing the payment identification to other received payment identifications to determine whether the payment identification has been received.

10. The computing apparatus of claim 1, wherein performing the sanity check of the payment transaction data and the travel record data comprises:
determining that a merchant associated with the payment transaction data matches a merchant associated with the travel record data;
determining that authorization of payment associated with the payment transaction data was successful;
determining whether there is an attempted follow-up operation or a pending follow-up operation associated with the payment transaction data;
determining that an amount and currency of payment associated with the payment transaction data is available; or
determining that a payment instrument associated with the payment transaction data matches a payment instrument associated with the travel record data.

11. A computer-implemented method, comprising:
receiving, by one or more processors at a payment integration server, a payment integration request associated with a travel record from a travel provider system, wherein the payment integration request includes a payment identification associated with a travel record identification;
obtaining, by the one or more processors, payment transaction data associated with the travel record from a payment gateway utilizing the payment identification;
obtaining, by the one or more processors, travel records data associated with the travel record from a reservation system, wherein the reservation system processed the travel record identification;
performing, by the one or more processors, a validity check of the travel record identification and the payment identification by determining that an authorization associated with the payment transaction data is valid based on an authorization time stamp associated with the travel record identification;
performing, by the one or more processors, a sanity check of the payment transaction data and the travel record data by comparing the payment identification and the travel record identification for a match;
generating, by the one or more processors, payment integration data based on integrating the results of the validity check of the travel record identification and the payment identification and the results of the sanity check of the payment transaction data and the travel record data; and
providing, by the one or more processors to the travel provider system, the payment integration data and payment integration instructions, wherein the travel provider system to integrates the payment integration data into the travel record based on the payment integration instructions.

12. The computer-implemented method of claim 11, wherein performing, by the one or more processors, the sanity check of the payment transaction data and the travel record data comprises determining, by the one or more processors, that the travel provider system has access to a particular set of data of the payment transaction data and the travel record data.

13. The computer-implemented method of claim 12, further comprising determining, by the one or more processors, configuration data according to the travel provider system having access to the particular set of data of the payment transaction data and the travel record data.

14. The computer-implemented method of claim 13, wherein generating, by the one or more processors, the payment integration data based on the validity check of the travel record identification and the payment identification and the sanity check of the payment transaction data and the travel record data is customizable based on the configuration data.

15. The computer-implemented method of claim 13, further comprising updating, by the one or more processors, an activation map based on the configuration data, wherein the activation map includes associations between a plurality of travel provider systems and a respective access level for each of the travel provider systems.

16. The computer-implemented method of claim 11, wherein performing, by the one or more processors, the sanity check of the payment transaction data and the travel record data comprises a record locator consistency check that includes an identification check between the payment identification and the travel record identification.

17. The computer-implemented method of claim 11, wherein the payment integration data includes at least one of data validity results, transactional data associated with the payment identification, a payment instrument, authorization information, authentication information, and risk assessment information.

18. A non-transitory computer storage medium encoded with a computer program, the computer program comprising a plurality of program instructions that when executed by one or more processors cause the one or more processors to perform operations comprising:
receiving, at a payment integration server, a payment integration request associated with a travel record from a travel provider system, wherein the payment integration request includes a payment identification associated with a travel record identification;
obtaining, at the payment integration server, payment transaction data associated with the travel record from a payment gateway utilizing the payment identification;
obtaining, at the payment integration server, travel records data associated with the travel record from a reservation system, wherein the reservation system processed the travel record identification;
performing, by the payment integration server, a validity check of the travel record identification and the payment identification by determining that an authorization associated with the payment transaction data is valid based on an authorization time stamp associated with the travel record identification;
performing, by the payment integration server, a sanity check of the payment transaction data and the travel record data by comparing the payment identification and the travel record identification for a match;
generating, by the payment integration server, payment integration data based on integrating the results of the validity check of the travel record identification and the payment identification and the results of the sanity check of the payment transaction data and the travel record data; and
providing, by the payment integration server to the travel provider system, the payment integration data and payment integration instructions, wherein the travel provider system to integrates the payment integration data into the travel record based on the payment integration instructions.

19. The non-transitory computer storage medium of claim 18, wherein performing, by the payment integration server, the sanity check of the payment transaction data and the travel record data comprises determining that the travel provider system has access to a particular set of data of the payment transaction data and the travel record data.

20. The non-transitory computer storage medium of claim 19, the operations further comprising determining, by the payment integration server, configuration data according to the travel provider system having access to the particular set of data of the payment transaction data and the travel record data.
